(19) United States
(12) Patent Application Publication
(10) Pub. No.: US 2010/0027263 A1
(43) Pub. Date: Feb. 4, 2010

(54) LIGHT EMITTING DIODE LIGHTING SET

(76) Inventor: Pei-Choa WANG, Gueishan Township (TW)

Correspondence Address: HDLS Patent & Trademark Services, P.O. BOX 220746, CHANTILLY, VA, 20153-0746, US

(21) Appl. No.: 12/185,294

(22) Filed: Aug. 4, 2008

(51) Int. Cl. F21V 29/02; F21V 21/00

(52) U.S. Cl. 362/249.06; 362/373

(57) ABSTRACT

A light emitting diode (LED) lighting set includes an aluminum extrusion radiating base, an LED module, a light focus plate, a diaphanous cover and two electrical connectors. The LED module has a substrate settled onto the radiating base and a plurality of LED lamps electrically connected onto the substrate. The light focus plate is fixed onto the radiating base and correspondingly formed under the LED lamps. The diaphanous cover connects the radiating base and correspondingly formed under the light focus plate. The electrical connectors separately connect two ends of the radiating base and also electrically connect the substrate. The aluminum extrusion radiating base, the diaphanous cover and the two electrical connectors define a closed space together, and the LED module and the light focus plate are received in the closed space; therefore, the LED lighting set has good heat dissipating performance and the usage life-span is greatly improved.

### BACKGROUND

The present invention relates to a lighting set, especially to a light emitting diode (LED) lighting set.

With the continuous development and progress of science and technology, electrical components are tending to become lighter, thinner, shorter and smaller, such as light emitting diode (LED), which has been widely used in lighting sets indoors or outdoor, due to the advantages of good luminance, long life-span, saving power and friendly to environment, etc. However, the most important issue which affects usage life-span thereof is to provide a working environment with proper temperature. Therefore, the present invention is to solve the heat dissipating issue of the lighting sets.

Conventional LED lighting set comprises a pipe, an LED module, and two electrical connectors; the pipe is transparent, with a number of heat dissipating holes formed thereon; the LED module is received in the pipe, which comprising a substrate and a plurality of LED lamps electrically connected to the substrate. When the LED module is electrified, the LED lamp then sends out light and at the same time emits heat, the heat produced thereby is transformed to the substrate and dissipated via the heat dissipating holes.

However, the conventional LED lighting set has the following drawback in actual use: since heat produced by the LED lamps is transformed to the substrate and sends out via the heat dissipating holes, the LED lamps is cooled via convection of outer atmosphere, therefore the cooling effect is not noticeable, thus the heat dissipating effect is affected, and thus the usage life-span of the LED lamps is reduced.

Therefore, to improve the heat dissipating performance and solve the shortcomings aforementioned, the inventor of the present invention studied with great concentration, combining with theories application, finally provides a product which is reasonably designed and could effectively improve the disadvantages above.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF SUMMARY

The present invention relates to an LED lighting set, with the design of aluminum extrusion radiating base and that of pasting an LED module onto the radiating base, the LED lighting set gains the advantages of good heat dissipating effect and furthermore improved usage life-span.

Thus, the present invention provides an LED lighting set, which comprising an aluminum extrusion radiating base, an LED module, a light focus plate, a diaphanous cover, and two electrical connectors; the LED module comprising a substrate settled onto the radiating base and a plurality of LED lamps electrically connected to the substrate, the light focus plate fixed onto the radiating base and correspondingly formed under the LED lamps; the diaphanous cover connecting the radiating base and correspondingly formed under the light focus plate; the two electrical connectors separately connecting two ends of the radiating base and also electrically connecting the substrate; wherein the aluminum extension radiating base, the diaphanous cover and the two electrical connectors defining a closed space together, and the LED module and the light focus plate being received therein.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a three-dimensional exploded schematic view of the present invention;

FIG. 2 is a three-dimensional complex schematic view of the present invention;

FIG. 3 is a cross-sectional schematic view of section 3-3 of FIG. 2;

FIG. 4 is a cross-sectional schematic view of section 4-4 of FIG. 3;

FIG. 5 is a schematic view illustrating a practical application of the present invention;

FIG. 6 is a schematic view of a second embodiment of the present invention;

FIG. 7 is a schematic view of a third embodiment of the present invention.

### DETAILED DESCRIPTION

The embodiments hereinafter will illustrate the features of the present invention in detail, with no restriction to the scope of the invention.

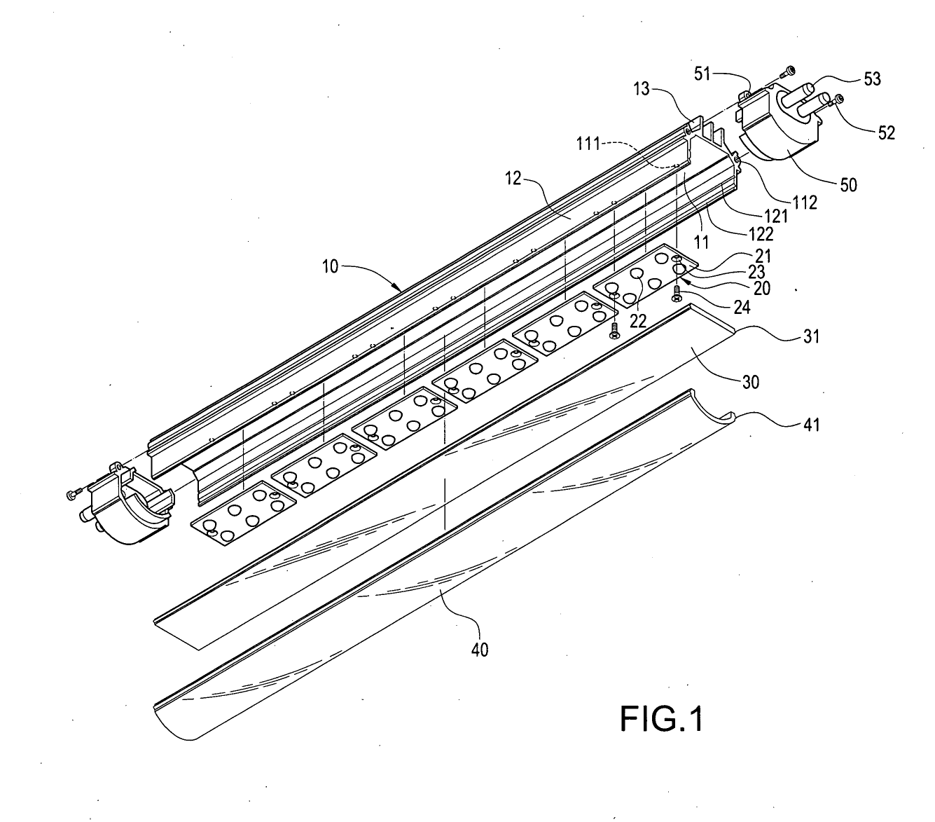

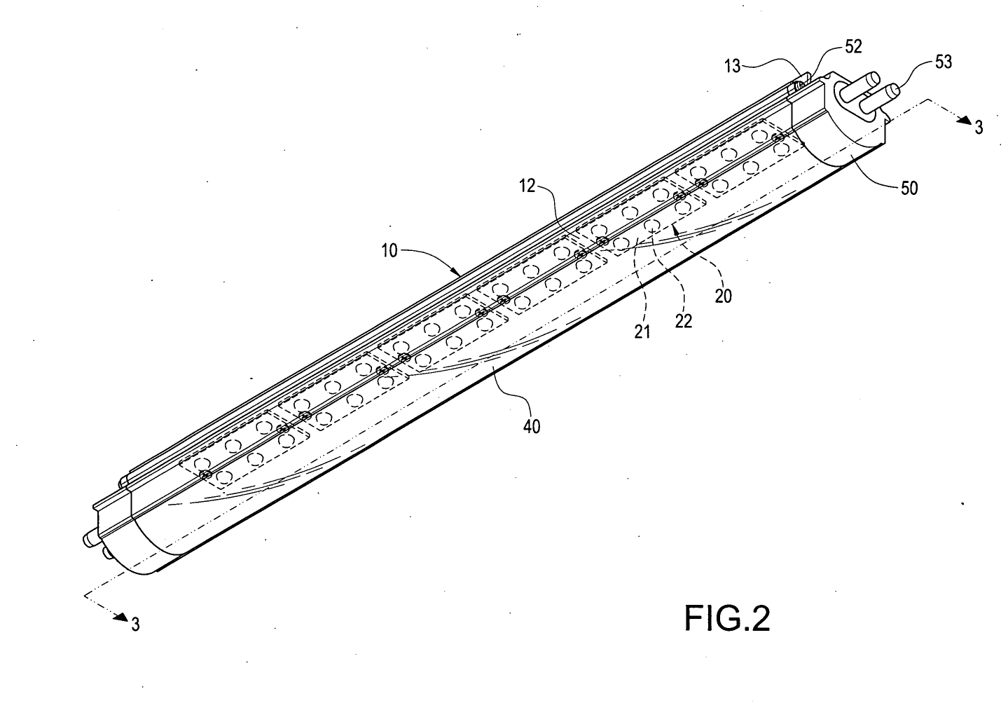

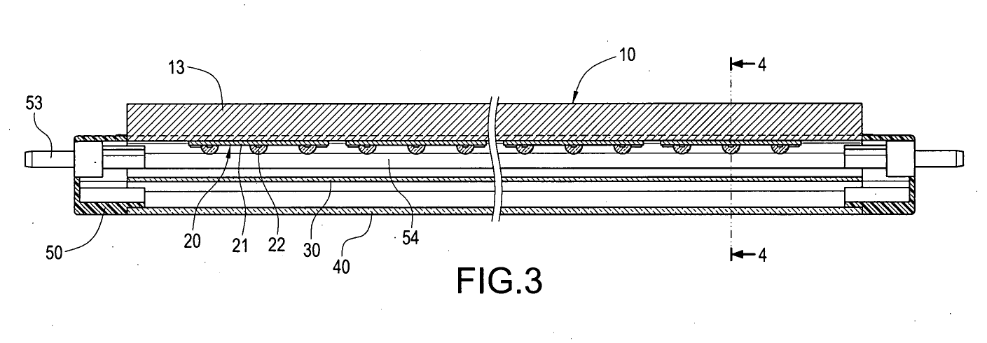

Referring to FIGS. 1 to 3, the LED lighting set comprises an aluminum extension radiating base 10, an LED module 20, a light focus plate 30, a diaphanous cover 40 and two electrical connectors 50.

The aluminum extension radiating base 10 comprises a base-plate 11, two side-plates 12 and several heat-dissipating fins 13, the side-plates 12 extending from a top surface of the base-plate 11, and heat-dissipating fins 13 extending from a bottom surface of the base-plate 11. The base-plate 11 comprises a plurality of screw holes 111. Each of the two side-plates 12 comprises a block groove 121 and a corresponding catching groove 122. Securing holes 112 are separately mounted at two ends of the base-plate 11.

The LED module 20 comprises a substrate 21 and several LED lamps 22, the LED lamps 22 are electrically connected to the substrate 21. The substrate 21 is settled onto the base-plate 11 of the radiating base 10, therefore making the LED module 20 received among the base-plate 11 and the two side-plates 12. The substrate 21 comprises several through holes 23 corresponding to the screw holes 111, enabling a bolt 24 drill through the through holes 23 and the screw holes 111, which makes the LED module 20 locked onto the base-plate 11. A material of the substrate 21 could be copper or silver, therefore leading to improvement of heat conducting rate. The LED lamps 22 could be a high power LED or general LED. The amount of the LED lamp 22 electrically connected to the substrate 21 could be single, not limited to plurality.

The light focus plate 30 is fixed onto the radiating base 10 and correspondingly formed under the LED lamps 22. The light focus plate 30 is used to focus the lights emitted from the LED lamps 22. Block strips 31 are formed at two sides of the light focus plate 30, which are held in the two block grooves 121. A material of the light focus plate 30 could be polymethyl methacrylate (PMMA) et al.

The diaphanous cover 40 connects the radiating base 10 and correspondingly formed under the light focus plate 30. Catching strips 41 are separately formed at two sides of the diaphanous cover 40 corresponding to the catching grooves 122 of the radiating base 10, being settled in the two catching grooves 122 correspondingly when assembled. A material of the diaphanous cover 40 could be a light guiding material or a plastic material with good light-permeating performance.

The two electrical connectors 50 separately connect two ends of the radiating base 10 and also electrically connect the substrate 21. There are via holes 51 mounted at the end of each electrical connector 50, adjacent to the radiating base 10. The via holes 51 correspond to the securing holes 112 separately, enabling a bolt 52 to drill through the via holes 51 and the securing holes 112, which makes the electrical connectors 50 locked onto the radiating base 10. Each electrical connector 50 comprises two electrical ends 53, each electrical ends 53 electrically connects to the substrate 21. The aluminum extension radiating base 10, the diaphanous cover 40 and the two electrical connectors 50 define a closed space 54 together, and the LED module 20 and the light focus plate 30 are received in the closed space 54.

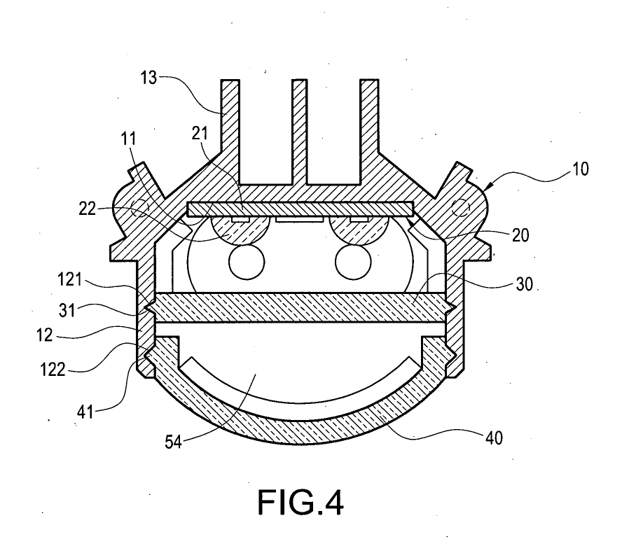

In assembly, referring to FIG. 4, first of all, locking the substrate 21 of the LED module 20 onto the base-plate 11 of the radiating base 10; secondly, blocking the two Block strips 31 of the light focus plate 30 into the two block grooves 121 of the radiating base 10, so as to fix the light focus plate 30; thirdly, buckling the two catching strips 41 of the diaphanous cover 40 into the two catching grooves 122 of the radiating base 10, so as to fix the diaphanous cover 40; finally, locking the two electrical connectors 50 to the two ends of the radiating base 10 via several bolts 52, therefore finishing the assembly.

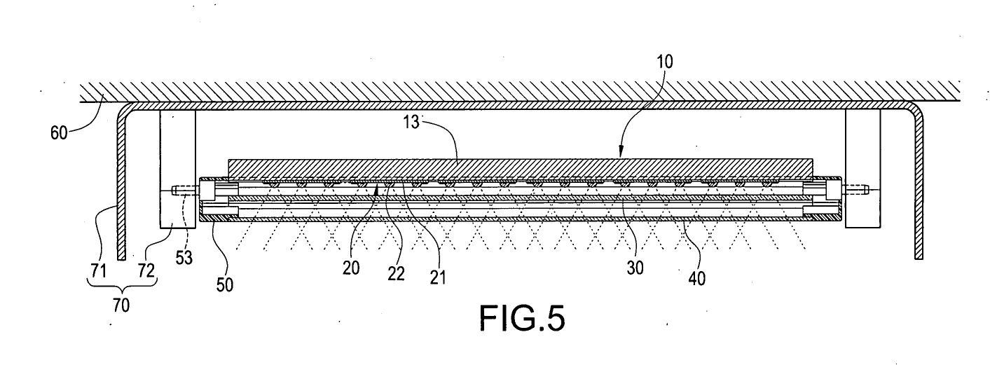

In using, referring to FIG. 5, installing the assembled LED lighting set of the present invention into a lamp holder 70, which is fixed under the ceiling 60. The lamp holder 70 comprises a cover 71 and two electrical sockets 72, the electrical sockets 72 is placed in the cover 71 and has been electrically connected to power supply. First of all, insert the electrically conductive ends 53 of the electrical connectors 50 into several jacks (not shown) of the two electrical sockets 72 and get fixed. After the LED module 20 is electrified, the LED lamps 22 produce light and heat. The light produced is then emitted out after being focused by the light focus plate 30. The heat produced is then conducted to the radiating base 10 and the heat-dissipating fin 13 thereon via the substrate 21, so as to dissipate the heat produced by the LED lamps 22, therefore reaches good heat dissipating performance, and prolong the usage life-span of the LED lamps 22.

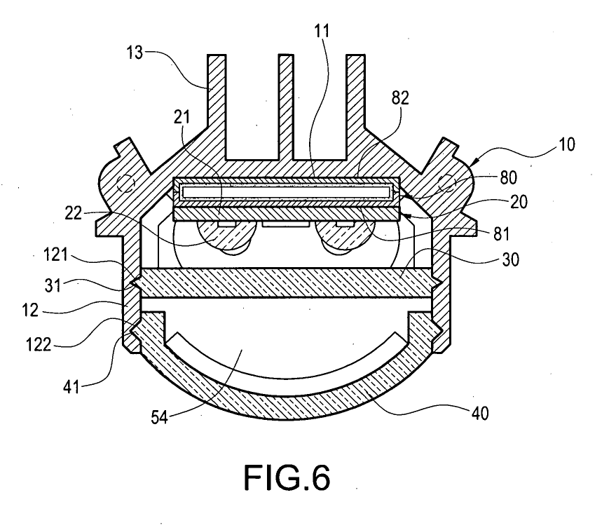

Referring to FIG. 6, it shows a schematic view of a second embodiment of the present invention. The difference between the second embodiment and the aforementioned embodiment is that the second embodiment further comprises a vapor chamber 80, which is installed between the base-plate 11 and the substrate 21. The vapor chamber 80 comprises a heat absorbing surface 81 and a heat dissipating surface 82. The heat absorbing surface 81 is pasted onto the substrate 21, and the heat dissipating surface 82 is pasted onto the base-plate 11. Therefore, the heat produced by the LED lamps 22 could be conducted out rapidly, and thus gains the same effect to the first embodiment.

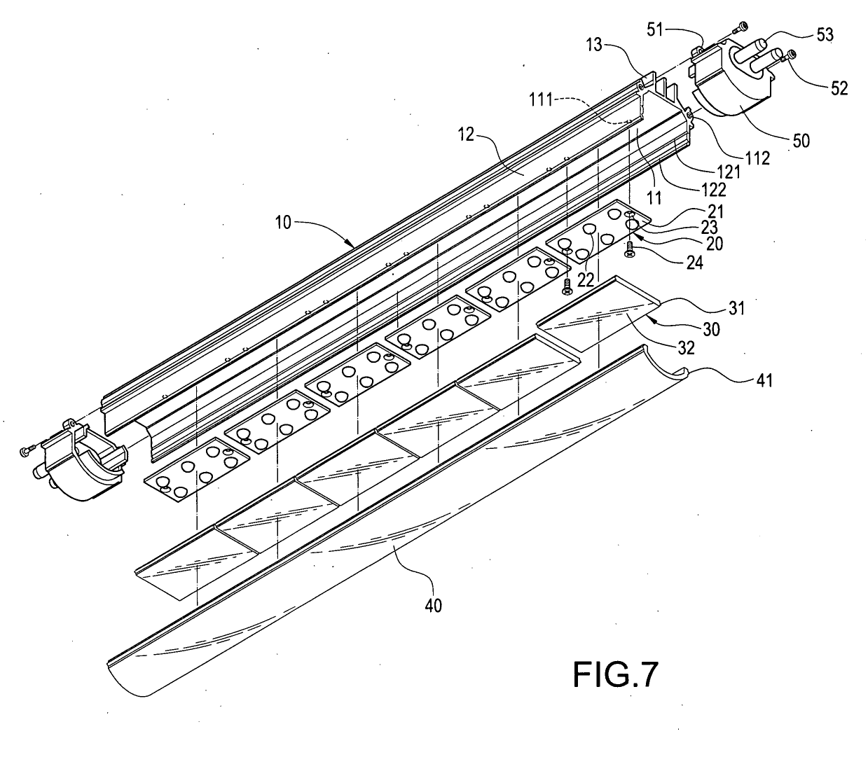

FIG. 7 shows a schematic view of a third embodiment of the present invention, the difference between the third embodiment and the first embodiment is that the light focus plate 30 comprises a number of light focus pieces 32, which is formed under the LED lamps 22 correspondingly.

Therefore, the present invention provides good heat dissipating effect, improves the usage life-span of the LED lamps 22, overcomes the shortcomings of prior art, thus has high industry application value.

What is claimed is:

1. An LED lighting set, comprising:
an aluminum extension radiating base (10);
an LED module (20), comprising a substrate (21) settled onto the radiating base (10) and a plurality of LED lamps (22) electrically connected to the substrate (21);
a light focus plate (30), fixed onto the radiating base (10) and correspondingly formed under the LED lamps (22);
a diaphanous cover (40), connecting the radiating base (10) and correspondingly formed under the light focus plate (30);
two electrical connectors (50), separately connecting to two ends of the radiating base (10) and also electrically connecting the substrate (21); wherein
the aluminum extension radiating base (10), the diaphanous cover (40) and the two electrical connectors (50) defining a closed space (54) together, and the LED module (20) and the light focus plate (30) being received therein.

2. The LED lighting set as described in claim 1, wherein the radiating base (10) comprises a base-plate (11) used for the substrate (21) pasting thereon and two side-plates (12) extending from a top surface of the base-plate (11), the LED module (20) is received among the base-plate (11) and the two side-plates (12).

3. The LED lighting set as described in claim 2, wherein the radiating base comprises a plurality of heat-dissipating fins (13) extending from a bottom surface of the base-plate (11).

4. The LED lighting set as described in claim 2, wherein the base-plate (11) comprises a plurality of screw holes (111), the substrate (21) comprises a plurality of through holes (23) corresponding to the screw holes (111), enabling a bolt (24) drilling through the through holes (23) and screw holes (111) to lock both of the radiating base (10) and the LED module (20) together.

5. The LED lighting set as described in claim 2, wherein the two side-plates (12) separately comprises a block groove (121), and block strips (31) are formed at two sides of the diaphanous cover (40) separately and locked in the block grooves (121).

6. The LED lighting set as described in claim 2, wherein the two side-plates (12) separately comprises a catching groove (122), and catching strips (41) are separately formed at two sides of the diaphanous cover (40) and locked in the catching grooves (122).

7. The LED lighting set as described in claim 2, wherein securing holes (112) are separately mounted at two ends of the base-plate (11), via holes (51) corresponding to the securing holes (112) are mounted at the end of each electrical connector (50), and bolts (52) drilling through each corresponding pair of the securing hole (112) and the via hole (51).

8. The LED lighting set as described in claim 2, further comprising a vapor chamber (80) settled between the base-plate (11) and the substrate (21).

9. The LED lighting set as described in claim 8, wherein the vapor chamber comprises a heat absorbing surface (81) and a heat dissipating surface (82), the heat absorbing surface is pasted onto the substrate, and the heat dissipating surface is pasted onto the base-plate (11).

10. The LED lighting set as described in claim 1, wherein a material of the substrate (21) is copper.

11. The LED lighting set as described in claim 1, wherein the LED lamp (22) is high power LED.

12. The LED lighting set as described in claim 1, wherein the light focus plate (30) is made from polymethyl methacrylate (PMMA).

13. The LED lighting set as described in claim 1, wherein the light focus plate (30) comprises a number of light focus pieces (32), which is formed under the LED lamps (22) correspondingly.

14. The LED lighting set as described in claim 1, wherein each electrical connector (50) comprises two electrical ends, and each electrical end electrically connects to the substrate (21).
